(19) United States
(12) Patent Application Publication
(10) Pub. No.: US 2019/0273832 A1
(43) Pub. Date: Sep. 5, 2019

(54) IMAGE FORMING APPARATUS, WEB PAGE DISPLAY METHOD, AND COMPUTER PROGRAM

(71) Applicant: KONICA MINOLTA, INC., Tokyo (JP)

(72) Inventors: Yoichi Kurumasa, Toyokawa-shi (JP); Yuji Kawamura, Toyokawa-shi (JP); Hideyuki Matsuda, Osaka (JP); Masayuki Ito, Tokyo (JP); Atsushi Kondo, Itami-shi (JP)

(73) Assignee: KONICA MINOLTA, INC., Tokyo (JP)

(21) Appl. No.: 16/268,546

(22) Filed: Feb. 6, 2019

(30) Foreign Application Priority Data
Mar. 1, 2018 (JP) 2018-036388

(51) Int. Cl. H04N 1/00

(52) U.S. Cl. CPC H04N 1/00464; H04N 1/00938; H04N 1/00482

(57) ABSTRACT

An image forming apparatus that executes a previously provided application, includes a displayer that causes a display to display a web page corresponding to a screen design of the application.

The entire disclosure of Japanese patent Application No. 2018-036388, filed on Mar. 1, 2018, is incorporated herein by reference in its entirety.

### BACKGROUND

Technological Field

The present invention relates to a technology for displaying a web page in an image forming apparatus, which has a so-called embedded application.

### Description of the Related art

In recent years, image forming apparatuses including various functions such as copying, scanning, and facsimile have been widely spread. These image forming apparatuses are sometimes referred to as “multi function peripherals (MFP)” or “multi function devices.”

To realize these functions, manufacturers create and install applications to those image forming apparatuses in advance. An application that is fixedly installed in advance in this manner is sometimes referred to as a “native application.”

Further, the image forming apparatuses have been further provided with a web browser. With the web browser, a web page can be downloaded from a web server and displayed. With this configuration, more varieties of service can be provided to users than before.

In addition, conventionally, as a technology of a user interface of the image forming apparatus, the following technology has been proposed.

A multi function device includes a display, and the display has a mode identification area and a setting information display area. In the mode identification area, pieces of identification information for identifying each of a plurality of modes provided in the multi function device are displayed. In the setting information display area, setting information of a mode corresponding to the currently selected identification information, from those pieces of identification information, is displayed. Then, in response to a selection of the identification information displayed in the mode identification area particularly, the multi function device displays setting information corresponding to the selected identification information in the setting information display area (JP 2006-115359 A).

As described above, with the image forming apparatuses, users can use service via a native application and also service via the Web.

However, conventionally, a user sometimes performs a wrong operation or feels uncertain when making a determination while using both of the service.

According to the technology described in JP 2006-115359 A, the above problem cannot be solved in a case where a user uses both service via a native application and service via the Web.

### SUMMARY

In view of the above problem, the present invention has an object to reduce user's operation error and uncertain determination in an image forming apparatus that provides service via a native application and service via the Web.

To achieve the abovementioned object, according to an aspect of the present invention, there is provided an image forming apparatus that executes a previously provided application, and the image forming apparatus reflecting one aspect of the present invention comprises a displayer that causes a display to display a web page corresponding to a screen design of the application.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating an example of an overall configuration of an image processing system;

FIG. 2 is a diagram illustrating an example of a hardware configuration of the image forming apparatus;

FIG. 3 is a diagram illustrating an example of a job list screen;

FIG. 4 is a diagram illustrating an example of a jam notification screen;

FIG. 5 is a diagram illustrating an example of a functional configuration of the image forming apparatus;

FIG. 6 is a diagram illustrating an example of design data;

FIG. 7 is a diagram illustrating an example of the design data;

FIG. 8 is a diagram illustrating an example of a web page;

FIG. 9 is a diagram illustrating an example of a web page file;

FIG. 10 is a diagram illustrating an example of a web page;

FIG. 11 is a diagram illustrating an example of a web page file;

FIG. 12 is a diagram illustrating an example of a web page;

FIG. 13 is a diagram illustrating an example of a web page file;

FIG. 14 is a diagram illustrating an example of a rewritten state of the web page;

FIG. 15 is a diagram illustrating an example of a rewritten state of the web page;

FIG. 16 is a diagram illustrating an example of a rewritten state of the web page; and

FIG. 17 is a flowchart illustrating an example of a flow of an overall process in the image forming apparatus.

### DETAILED DESCRIPTION OF EMBODIMENTS

Hereinafter, one or more embodiments of the present invention will be described with reference to the drawings. However, the scope of the invention is not limited to the disclosed embodiments.

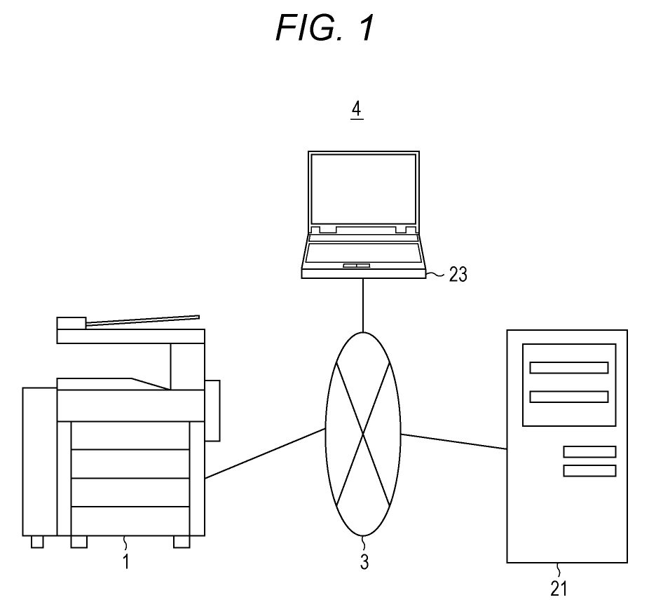

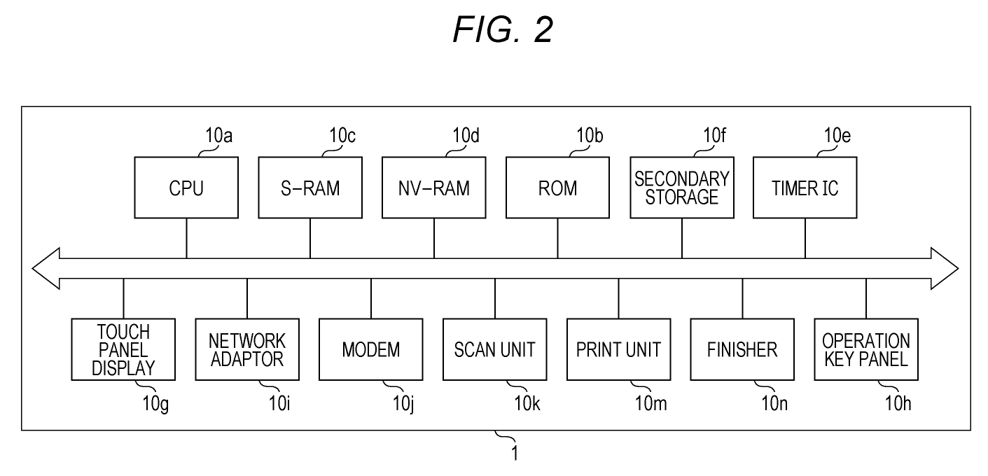

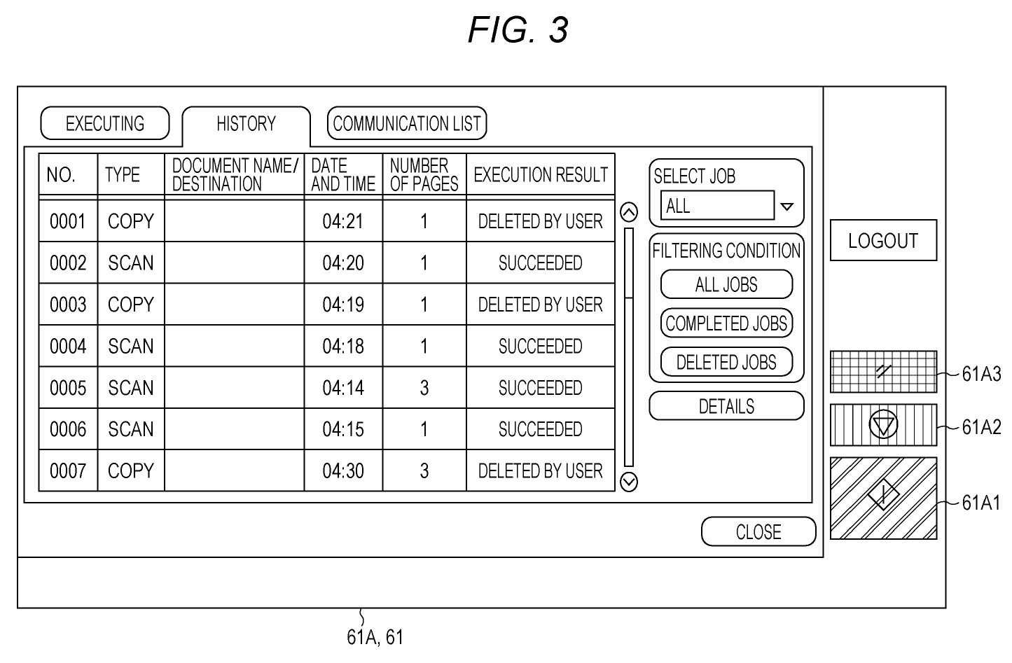

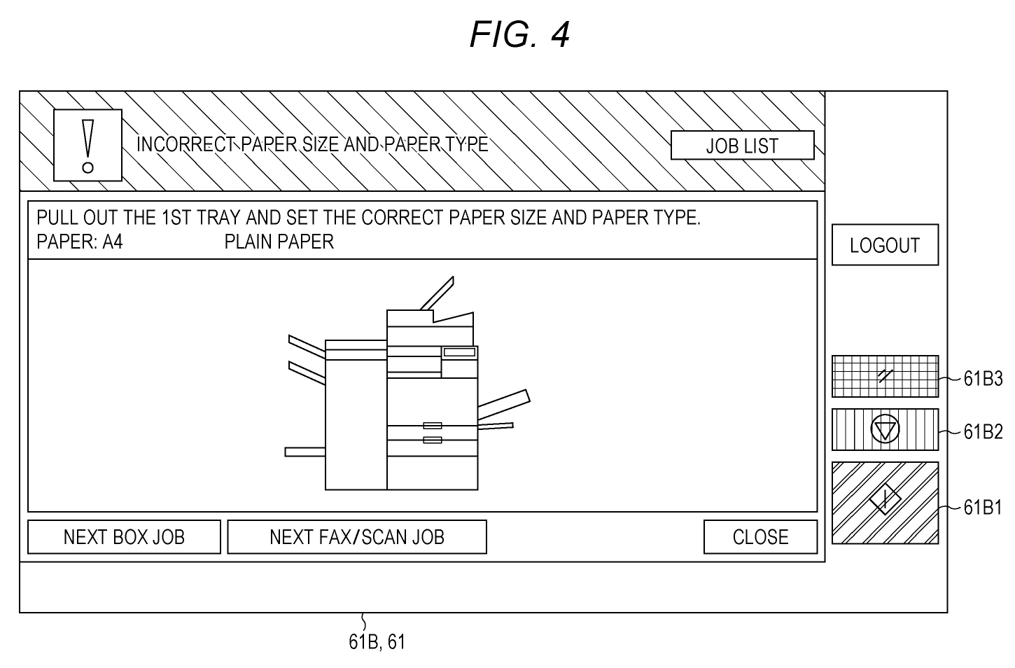

FIG. 1 is a diagram illustrating an example of an overall configuration of an image processing system 4. FIG. 2 is a diagram illustrating an example of a hardware configuration of an image forming apparatus 1. FIG. 3 is a diagram illustrating an example of a job list screen 61A. FIG. 4 is a diagram illustrating an example of a jam notification screen 61B.

The image processing system 4 illustrated in FIG. 1 is a system for printing an image on a sheet or handling the image as electronic data and is composed of the image forming apparatus 1, a web server 21, a terminal device 23, a communication line 3, and the like.

The image forming apparatus 1, web server 21, and terminal device 23 can communicate with one another via the communication line 3. As the communication line 3, a local area network (LAN), the Internet, a public line, an exclusive line, and the like are used.

The image forming apparatus 1 is an apparatus that integrates functions of copying, PC printing, faxing, scanning, storing data (box), and the like. In general, such an apparatus is sometimes referred to as a “multi function device” or “multi function peripherals (MFP).”

A PC print function is a function to print an image on a sheet based on image data received from the terminal device 23. The function is also referred to as “network printing,” “network print,” or the like.

A box function is a function for allocating a memory area called “box,” “personal box” or the like to each user so that each user can store and manage image data and the like according to their memory area. The box corresponds to a “folder” or a “directory” in a personal computer.

As illustrated in FIG. 2, the image forming apparatus 1 is composed of a central processing unit (CPU) 10a, a read only memory (ROM) 10b, a static random access memory (S -RAM) 10c, a non volatile random access memory (NV-RAM) 10d, a timer integrated circuit (IC) 10e, a secondary storage 10f, a touch panel display 10g, an operation key panel 10h, a network adaptor 10i, a modem 10j, a scan unit 10k, a print unit 10m, a finisher 10n, and the like.

The S-RAM 10c is a working memory and is used to temporarily store a result of a process in the CPU 10a, data transmitted from another device, or the like.

The NV-RAM 10d is used to back up data related to various settings (for example, Internet Protocol (IP) address, fax number, contact information, screen text size, language, or the like) of the image forming apparatus 1 itself. The timer IC 10e is a circuit for measuring time.

In the ROM 10b or secondary storage 10f, an operating system and a program such as an application to realize the above functions are stored. In the ROM 10b or secondary storage 10f, a certain application is fixedly stored in advance before the image forming apparatus 1 is shipped. In the following, such an application is referred to as a “native application.” The native application may be also referred to as an “embedded application.”

Various screens 61 are prepared for each native application in advance. For example, a job list screen 61A illustrated in FIG. 3, a jam notification screen 61B illustrated in FIG. 4, and the like are prepared as the screens 61. These screens 61 have a uniform design. In other words, the screens 61 are drawn based on a standard of a so-called embedded user interface (UI).

For example, as an object (element) for making the image forming apparatus 1 start a job or making the image forming apparatus 1 accept information input by a user, that is, an object to proceed a next step, an object in a green-like color is used. In the following, the object to proceed the process to a next step is referred to as a “proceeding object.” A button 61A1 of the job list screen 61A and a button 61B1 of the jam notification screen 61B are examples of the proceeding object.

Furthermore, as an object for making the image forming apparatus 1 suspend a job being executed, making the image forming apparatus 1 delete stored data, that is, an object for providing a negative instruction, an object in a red-like color is used. In the following, the object to provide a negative instruction is referred to as a “terminating object.” The button 61A2 of the job list screen 61A and the button 61B2 of the jam notification screen 61B are examples of the terminating object.

Alternatively, as an object for resetting information input by the user before the image forming apparatus 1 accepts the information and making the image forming apparatus 1 switch the screen to be displayed to a home screen, that is, an object for resetting, an object in a yellow-like color is used. In the following, an object for resetting is referred to as a “resetting object.” A button 61A3 of the job list screen 61A and a button 61B3 of the jam notification screen 61B are examples of the resetting object.

Here, as an example of the objects, there is an object used by the user to input instruction or information, such as a button, a scroll bar, a pull-down menu, and a key. Such an object is sometimes referred to as a “control.”

Furthermore, in screens for giving a warning to the user, a background of the entire screen or a specific area (for example, a title area) uniformly has an orange-like color. Alternatively, in screens for calling attention to the user, uniformly have a background of the entire screen or a specific area uniformly has a yellow-like color. In the following, the screen for giving a warning to the user and the screen for calling attention to the user are referred to as “warning screen” and “attention screen” respectively.

For example, the jam notification screen 61B is an attention screen and a background color of the title area is orange.

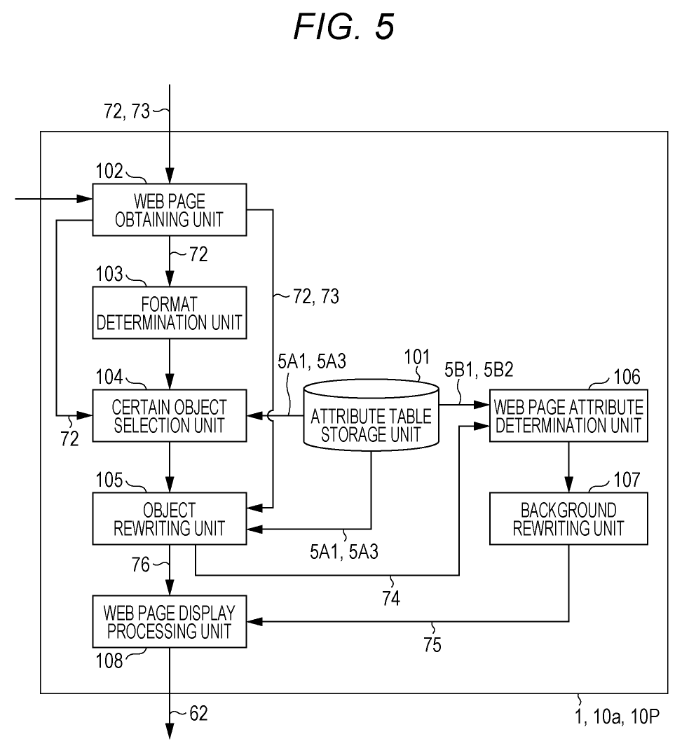

Furthermore, in the ROM 10b or the secondary storage 10f, a web browser 10P (see FIG. 5) is stored.

A program stored in the ROM 10b or the secondary storage 10f, such as a native application, the web browser 10P, and the like, is loaded to the S-RAM 10c and executed by the CPU 10a according to need. As the secondary storage 10f, a hard disk, a solid state drive (SSD) or the like is used.

The touch panel display 10g displays a screen to show a message to the user, a screen used by the user to input a command or information, a screen to show a result of a process executed by the CPU 10a, and the like. Furthermore, the touch panel display 10g transmits a signal, which indicates a touched position, to the CPU 10a.

The operation key panel 10h is a so-called hardware keyboard and is composed of a numeric keypad, a start key, a stop key, a function key, and the like.

The network adaptor 10i communicates with the web server 21 and terminal device 23 by using a protocol such as transmission control protocol/internet protocol (TCP/IP). As the network adaptor 10i, a network interface card (NIC), a wireless LAN adapter, or the like is used.

The modem 10j transmits and receives image data to and from a facsimile terminal by using a protocol such as G3.

The scan unit 10k reads an image drawn on a sheet and generates image data. Furthermore, the scan unit 10k includes an auto document feeder (ADF) and can continuously read images from a plurality of sheets respectively.

The print unit 10m prints an image indicated on image data received or read by the network adaptor 10i or modem 10j from another device in addition to an image read by the scan unit 10k.

The finisher 10n performs post-processing on a printed sheet processed by the print unit 10m according to need. The post-processing may be a stapling process, a hole-punching process, a folding process, and the like.

The web server 21 provides a web page to the image forming apparatus 1, terminal device 23, and the like.

The terminal device 23 is a client, which receives service of the image forming apparatus 1 or web server 21. As the terminal device 23, a personal computer, a smartphone, a tablet computer, and the like are used.

Here, the web browser 10P downloads data of the web page from the web server 21 and renders the web page to be displayed on the touch panel display 10g, as in the case of a conventional web browser. Here, the web browser 10P can also display the web page corresponding to a screen design of the native application. In the following, a configuration therefor will be described.

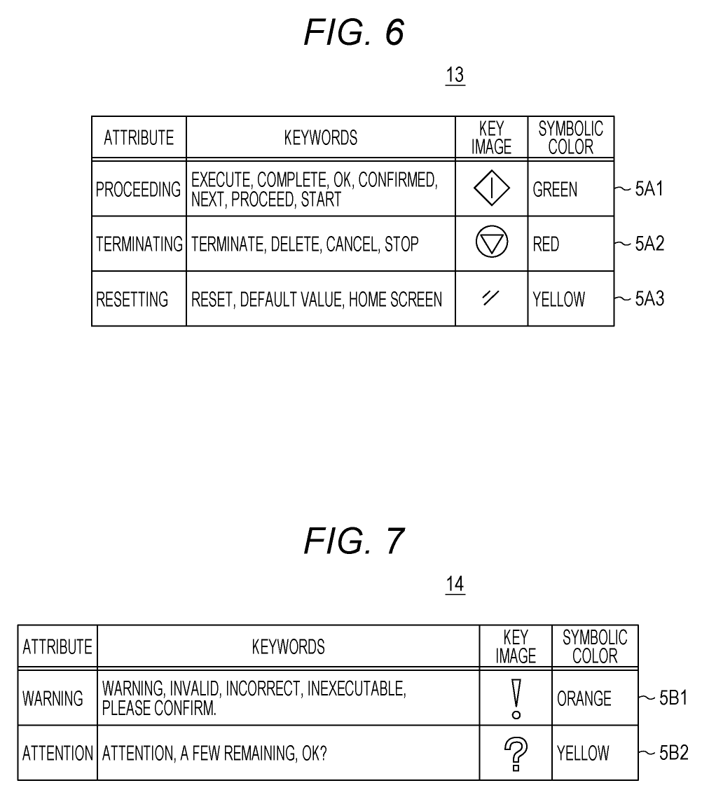

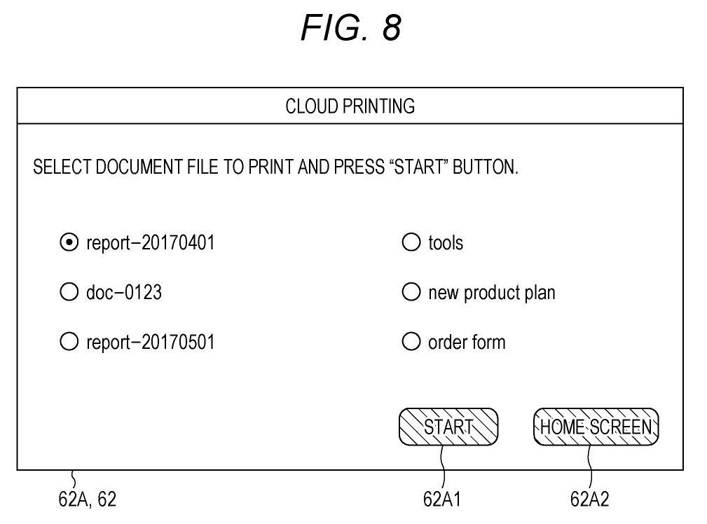

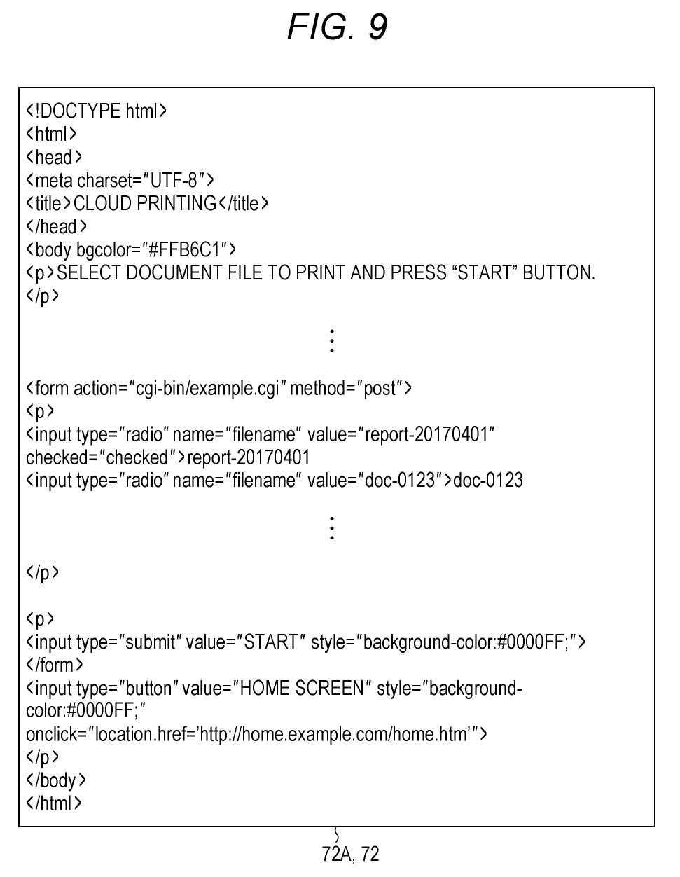

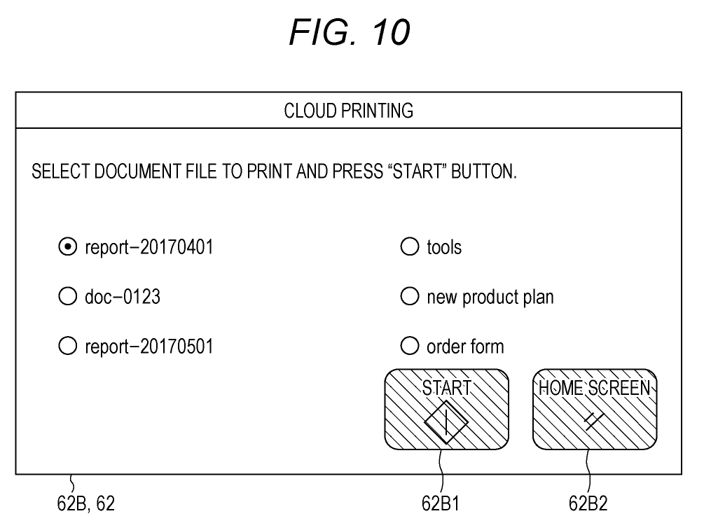

FIG. 5 is a diagram illustrating an example of a functional configuration of the image forming apparatus 1. FIG. 6 is a diagram illustrating an example of design data 5A1 to 5A3. FIG. 7 is a diagram illustrating an example of design data 5B1 to 5B2. FIG. 8 is a diagram illustrating an example of a web page 62A. FIG. 9 is a diagram illustrating an example of a web page file 72A. FIG. 10 is a diagram illustrating an example of a web page 62B.

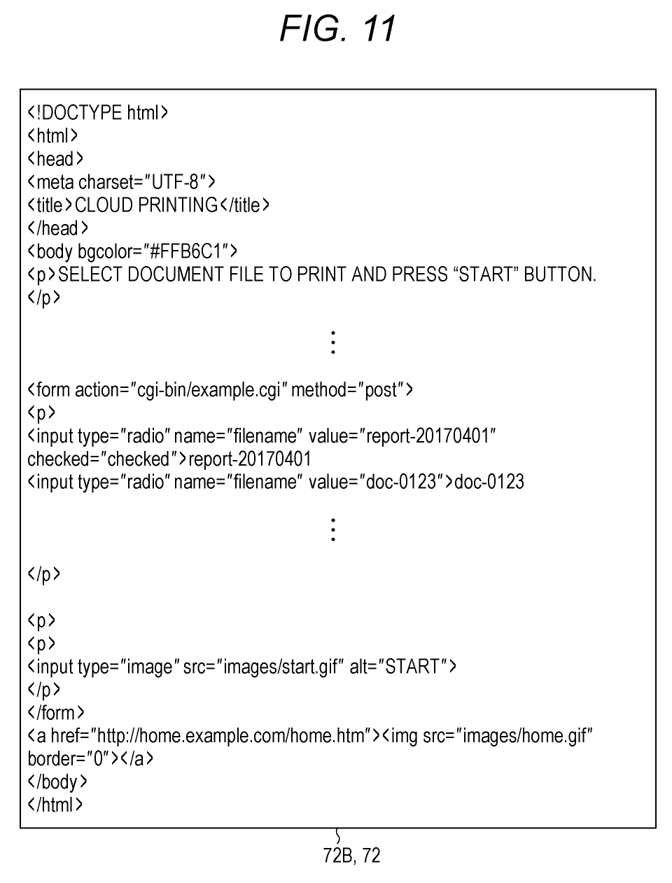

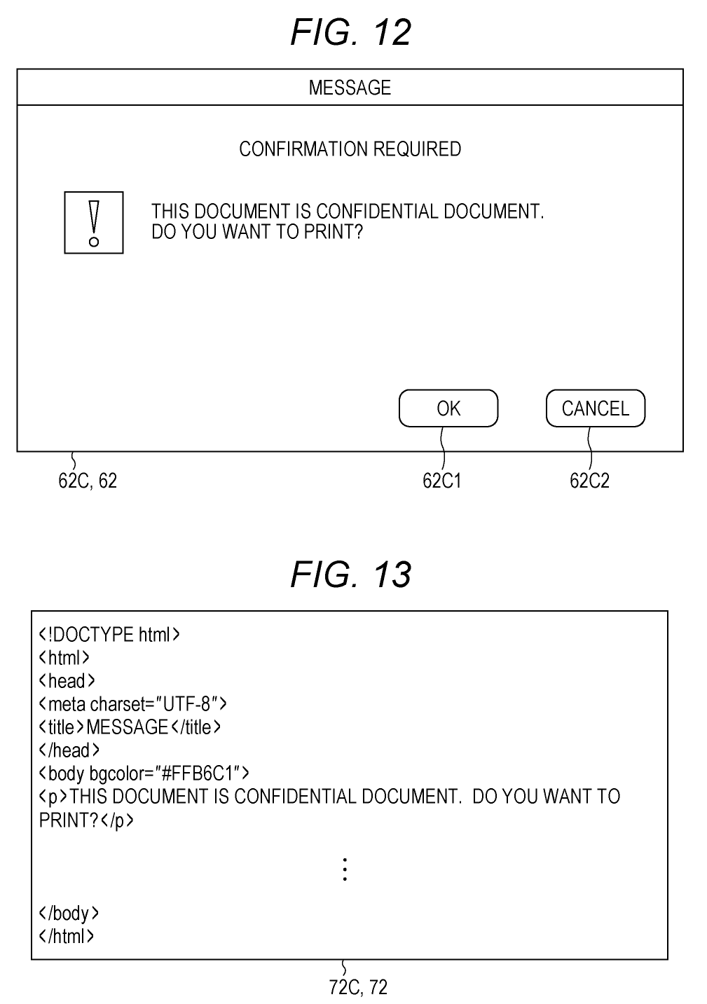

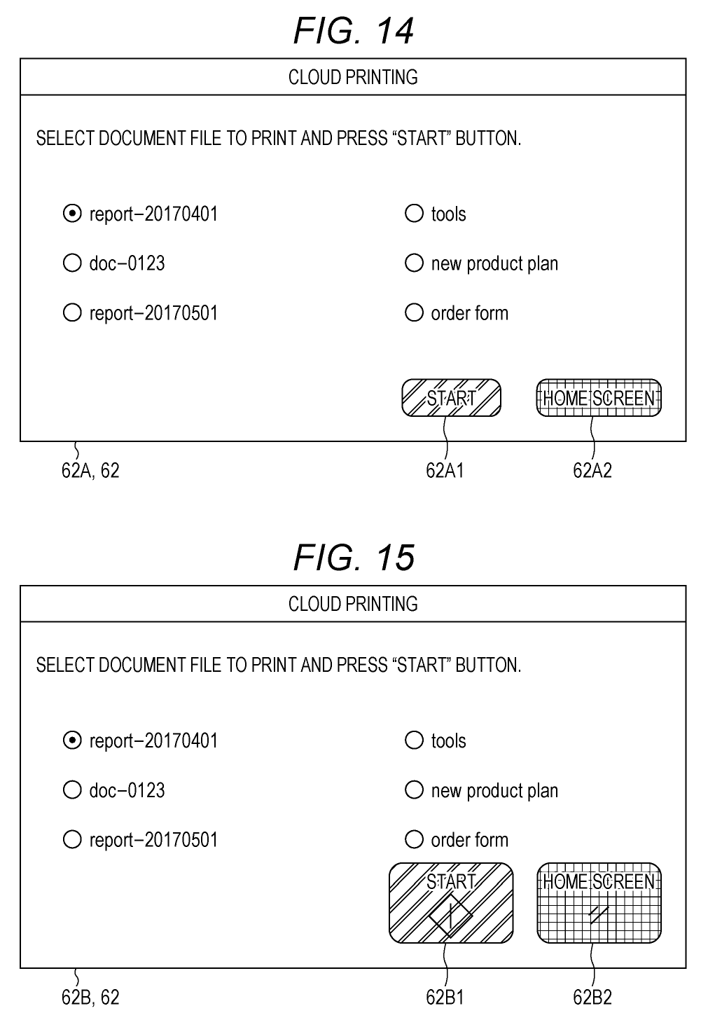

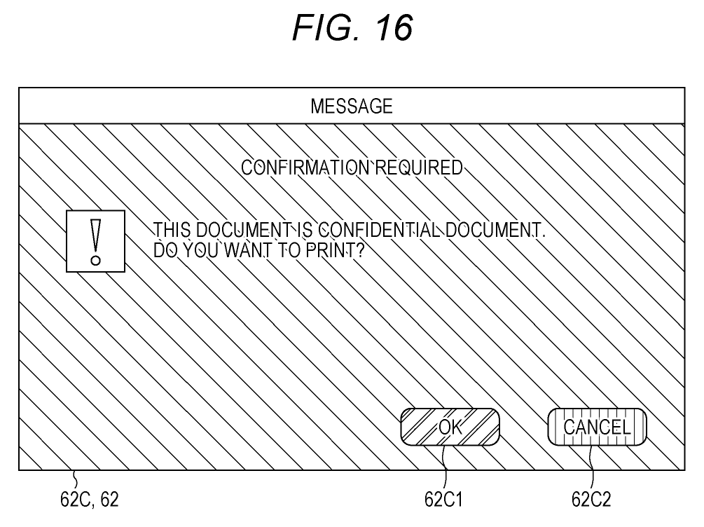

FIG. 11 is a diagram illustrating an example of a web page file 72B. FIG. 12 is a diagram illustrating an example of a web page 62C. FIG. 13 is a diagram illustrating an example of a web page file 72C. FIG. 14 is a diagram illustrating an example of a rewritten state of the web page 62A. FIG. 15 is a diagram illustrating an example of a rewritten state of the web page 62B. FIG. 16 is a diagram illustrating an example of a rewritten state of the web page 62C.

With the web browser 10P, an attribute table storage unit 101, a web page obtaining unit 102, a format determination unit 103, a certain object selection unit 104, an object rewriting unit 105, a web page attribute determination unit 106, a background rewriting unit 107, a web page display processing unit 108, and the like as illustrated in FIG. 5 are realized in the image forming apparatus 1.

In the attribute table storage unit 101, an object attribute table 13 and a background attribute table 14 are stored.

In the object attribute table 13, as illustrated in FIG. 6, design data 5A1, 5A2, and 5A3 of the proceeding object, terminating object, and resetting object are stored, respectively.

In the design data 5A1, the following information related to the proceeding object is indicated. A “keyword” is a phrase used in a text expressing a proceeding object. A “key image” is an image used as a sign or a symbol expressing a proceeding object. A “symbolic color” is a color used as a symbolic color of the proceeding object in the native application. According to the present embodiment, green is indicated as the symbolic color.

Also, in the design data 5A2 and design data 5A3, similar information related to the terminating object and resetting object is indicated, respectively.

In other words, in the design data 5A2, a phrase, which may be used as a text expressing the terminating object, an image, which may be used as a sign or a symbol expressing the terminating object, and a color used as a symbolic color of the terminating object, which is red, are indicated.

In the design data 5A3, a phrase, which may be used as a text expressing the resetting object, an image, which may be used as a sign or a symbol expressing the resetting object, and a color used as a symbolic color of the resetting object, which is yellow, are indicated.

In the background attribute table 14, as illustrated in FIG. 7, pieces of design data 5B1 and 5B2 of a warning screen and an attention screen are stored, respectively.

In the design data 5B1, the following information related to the warning screen is indicated. A “keyword” is a phrase, which may be used in the warning screen. A “key image” is an image such as a sign or a symbol, which may be used in the warning screen. A “symbolic color” is a color used as a symbolic color of the warning screen in the native application.

In the design data 5B2, similar information related to the attention screen is also indicated. In other words, in the design data 5B2, a phrase and an image, which may be used in a warning screen and a color as a symbolic color are indicated.

The web page obtaining unit 102 obtains a web page file 72 to display a web page 62, by downloading the file from the web server 21. The web page file 72 is a text file written in Hypertext Markup Language (HTML).

For example, in a case where the web page 62A for cloud printing illustrated in FIG. 8 is displayed as the web page 62, the web page obtaining unit 102 obtains a web page file 72A including the content illustrated in FIG. 9 as a web page file 72. It is noted that “cloud printing” is a function for downloading a file from a cloud server and printing a document indicated in the file.

Here, on the web page 62A, blue is used as a main color arrangement. For example, blue is used for a background color of the button 62A1 and button 62A2. On the later described web page 62B and web page 62C, blue is also used as a main color arrangement.

Ina case where a part of the web page 62 is reproduced with an image file 73, a path of the image file 73 is indicated in the web page file 72. Thus, when a path is indicated in the web page file 72, the web page obtaining unit 102 further obtains the image file 73 based on the path.

For example, in a case where the web page 62B for cloud printing is displayed as the web page 62 as illustrated in FIG. 10, the web page obtaining unit 102 obtains the web page file 72B including the content illustrated in FIG. 11 as well as the image file 73 corresponding to the path indicated in the web page file 72B. In this example, as the image file 73, the web page obtaining unit 102 obtains an image file 73 of an icon 62B1 and an image file 73 of an icon 62B2.

When the web page obtaining unit 102 obtains the web page file 72, the format determination unit 103 determines whether the web page file 72 is a file in a format of a web page. For example, when a tag including a character string of “!DOCTYPE html” is written in the web page file 72, it is determined that the file is in a format of a web page.

When it is determined that the web page file 72 is a file in a format of a web page, the certain object selection unit 104 selects a proceeding object, a terminating object, and a resetting object from the web page 62 as follows.

The certain object selection unit 104 searches one of the keywords listed in the design data 5A1 (see FIG. 6) from the codes expressing the object indicated in the web page file 72. According to the present embodiment, the certain object selection unit 104 searches a code that includes one of keywords of “execute,” “complete,” “OK,” “confirmed,” “next,” “proceed,” and “start.” Then, when a code including one of the keywords is found, an object to be reproduced based on the code is selected as a proceeding object.

In a similar manner, the certain object selection unit 104 searches a code including one of the keywords indicated by the design data 5A2 from the codes of objects indicated in the web page file 72. According to the present embodiment, the certain object selection unit 104 searches a code including one of the keywords of “terminate,” “delete,” “cancel,” and “stop.” Then, when a code including one of the keywords is found, an object to be reproduced based on the code is selected as a terminating object.

In the similar manner, the certain object selection unit 104 searches a code including one of the keywords indicated by the design data 5A3 from the codes of objects indicated in the web page file 72. According to the present embodiment, a code including one of the keywords of “reset,” “default value,” and “home screen” is searched. Then, when a code including one of the keywords is found, an object to be reproduced based on the code is selected as a resetting object.

Further, when one or more image files 73 are obtained together with the web page file 72, the certain object selection unit 104 detects a code including a key image indicated by the design data 5A1 from images (objects) to be reproduced based on the image file 73, as a proceeding object.

In a similar manner, the certain object selection unit 104 detects a code including a key image indicated by the design data 5A2, from objects to be reproduced based on the respective image files 73, as a terminating object.

In a similar manner, the certain object selection unit 104 detects a code including a key image indicated by the design data 5A3, from objects to be reproduced based on the respective image files 73, as a resetting object.

With the above described processes by the certain object selection unit 104, in a case where the web page 62 and web page file 72 are web page 62A (see FIG. 8) and web page file 72A (see FIG. 9) respectively, the button 62A1 and button 62A2 are selected as a proceeding object and a resetting object, respectively.

Further, in a case where the web page 62 and web page file 72 are web page 62B (see FIG. 10) and web page file 72B (see FIG. 11) respectively, the icon 62B1 and icon 62B2 are selected as a proceeding object and a resetting object respectively.

Note that a subject to be selected may be limited to a certain object in a web page 62. For example, a subject to be selected may be limited to a text or an image in which a button and a hyperlink are set.

The object rewriting unit 105 rewrites the web page file 72 or image file 73 so that each color of the proceeding object, terminating object, and resetting object selected by the certain object selection unit 104 is changed to symbolic colors indicated by the design data 5A1, 5A2, and 5A3, respectively.

For example, from the web page 62A, the button 62A1 is selected as a proceeding object and the button 62A2 is selected as a resetting object, as described above.

Thus, the object rewriting unit 105 rewrites the web page file 72A so that the color of the button 62A1 is changed to the symbolic color indicated by the design data 5A1. More specifically, the object rewriting unit 105 rewrites “#000OFF” in “background-color:#000OFF” included in the code of the button 62A1 with a value that indicates green, “#008000,” for example. Further, the object rewriting unit 105 rewrites the web page file 72A so that the color of the button 62A2 is changed to the symbolic color indicated in the design data 5A2. More specifically, the object rewriting unit 105 rewrites “#000OFF” in “background-color:#000OFF” included in the code of the button 62A2 with a value that indicates yellow, “#FFFF00,” for example.

Further, from the web page 62B, the icon 62B1 is selected as a proceeding object and the icon 62B2 is selected as a resetting object, as described above.

Thus, the object rewriting unit 105 rewrites the image file 73 of the icon 62B1 so that the background color of the icon 62B1 is changed to the symbolic color, which is green, indicated in the design data 5A1. In a similar manner, the object rewriting unit 105 rewrites image file 73 of the icon 62B2 so that the background color of the icon 62B2 is changed to a symbolic color, which is yellow, indicated in the design data 5A2.

In the following, the web page file 72 that is rewritten by the object rewriting unit 105 is referred to as a “web page file 74.” Further, the image file 73 that is rewritten by the object rewriting unit 105 is referred to as an “image file 76.”

Here, when the web page file 72 has not been rewritten, the web page file 72 is used as the web page file 74 in the web page attribute determination unit 106 and background rewriting unit 107. Further, when the image file 73 has not been rewritten, the image file 73 is used as the image file 76 in the web page display processing unit 108.

The web page attribute determination unit 106 determines whether or not the web page 62 is a warning screen or an attention screen as follows.

The web page attribute determination unit 106 searches one of the keywords indicated in the design data 5B1 (see FIG. 7) from the codes expressing the objects indicated in the web page file 74. According to the present embodiment, the web page attribute determination unit 106 searches a code including one of the keywords of “warning,” “invalid,” “incorrect,” “inexecutable,” and “Please confirm.” Then, when such a code is found, it is determined that the web page 62 corresponds to a warning screen.

Alternatively, when one or more image files 73 are obtained together with the web page file 72, the web page attribute determination unit 106 searches a code including one of the key images indicated in the design data 5B1 from images (objects) to be reproduced based on the image files 73 respectively. Then, when such an image is found, it is determined that the web page 62 corresponds to a warning screen.

When the web page 62 is not a warning screen, the web page attribute determination unit 106 searches a code including one of the keywords indicted in the design data 5B2 from the codes expressing the objects indicated by the web page file 74. According to the present embodiment, the web page attribute determination unit 106 searches a code including one of the keywords of “attention,” “a few remaining,” and “OK?.” Then, when such a code is found, it is determined that the web page 62 corresponds to the attention screen.

Alternatively, when one or more image files 73 are obtained together with the web page file 72, the web page attribute determination unit 106 searches a code including one of the key images indicated in the design data 5B2 from images to be reproduced based on the image file 73. Then, when such an image is found, it is determined that the web page 62 corresponds to an attention screen.

When it is determined that the web page 62 is a warning screen by the web page attribute determination unit 106, the background rewriting unit 107 rewrites the web page file 74 of the web page 62 so that the entire background color of the web page 62 is changed to the symbolic color, which is orange, indicated in the design data 5B1. Alternatively, when it is determined that the web page 62 is an attention screen, the web page file 74 of the web page 62 is written so that the entire background color of the web page 62 is changed to the symbolic color, which is yellow, indicated in the design data 5B2.

For example, when the web page 62 is the web page 62C as illustrated in FIG. 12 and the original web page file 72 of the web page file 74 is the web page file 72C as illustrated in FIG. 13, “#FFB6C1” in “<body bgcolor=”#FFB6C1“>” is rewritten to a value indicating orange, which is “#FF4500,” for example.

Here, a button 62C1 a button 62C2, which are arranged on the web page 62C, correspond to a proceeding object and a terminating object, respectively. Thus, before the process by the background rewriting unit 107, the button 62C1 and button 62C2 are respectively selected as a proceeding object and a terminating object by the certain object selection unit 104. Then, the object rewriting unit 105 rewrites the web page file 74 so that the colors of the button 62C1 and button 62C2 are changed to green and red respectively.

In the following, the web page file 74, which has been rewritten by the background rewriting unit 107, is referred to as a “web page file 75.”

The web page display processing unit 108 renders the web page 62 and displays the web page 62 on the touch panel display 10g based on the web page file 72 rewritten by the object rewriting unit 105 or background rewriting unit 107 according to need or based on the image file 73 rewritten by the object rewriting unit 105 according to need. With this configuration, the web page 62 is displayed on the touch panel display 10 g in a state that the color is changed.

For example, as illustrated in FIG. 14, the web page 62A (see FIG. 8) is displayed after the background color of the button 62A1 is changed to green and the background color of the button 62A2 is changed to yellow.

As illustrated in FIG. 15, the web page 62B (see FIG. 10) is displayed after the background color of the icon 62B1 is changed to green and the background color of the icon 62B2 is changed to yellow.

As illustrated in FIG. 16, the web page 62C (see FIG. 12) is displayed after the background color of the button 62C1 is changed to green, the background color of the button 62C2 is changed to red, and the background color of the web page 62C is changed to orange.

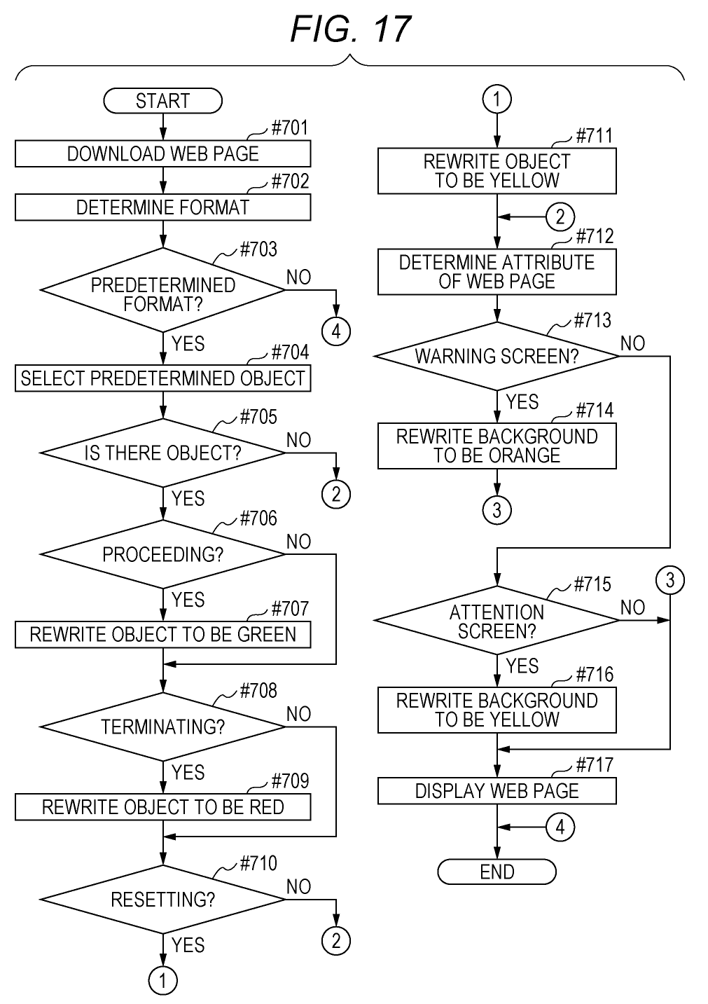

FIG. 17 is a flowchart for describing an example of a flow of the entire process in the image forming apparatus 1.

Next, a flow of the entire process that the web page 62 is displayed in the image forming apparatus 1 will be described with reference to the flowchart.

Based on the web browser 10P, the process is executed in the image forming apparatus 1 with a procedure illustrated in FIG. 17.

When a predetermined event such as specification of uniform resource locator (URL) by the user occurs, the image forming apparatus 1 downloads the web page file 72 of the web page 62 corresponding to the event (#701 in FIG. 17). When a path to the image file 73 is indicated in the web page file 72, the image file 73 is also downloaded based on the path.

The image forming apparatus 1 checks whether or not the format of the web page file 72 is a web page format (#702). Then, when it is determined that the format is a web page format (Yes in #703), an object of a predetermined category is selected from the web page 62 (#704). According to the present embodiment, a proceeding object, a terminating object, and a resetting object are selected.

When an object of a predetermined category has been successfully selected (Yes in #705), the image forming apparatus 1 rewrites the web page file 72 as follows.

When a proceeding object is selected (Yes in #706), the image forming apparatus 1 rewrites the web page file 72 or image file 73 so that the background color of the proceeding object becomes the symbolic color, which is green, indicated in the design data 5A1 (see FIG. 6) (#707).

When the terminating object is selected (Yes in #708), the image forming apparatus 1 rewrites the web page file 72 or image file 73 so that the background color of the terminating object becomes the symbolic color, which is red, indicated in the design data 5A2 (#709).

When the resetting object is selected (Yes in #710), the image forming apparatus 1 rewrites the web page file 72 or image file 73 so that the background color of the resetting object becomes the symbolic color, which is yellow, indicated in the design data 5A3 (#711). With this configuration, the web page file 74 is obtained.

Further, the image forming apparatus 1 determines whether or not the web page 62 corresponds to a warning screen or an attention screen (#712).

When the web page 62 corresponds to the warning screen (Yes in #713), the image forming apparatus 1 rewrites the web page file 74 so that the entire background color of the web page 62 becomes the symbolic color, which is orange, indicated in the design data 5B1 (see FIG. 7) (#714). Here, when rewriting in any steps #707, #709, and #711 is not executed, the web page file 72 is rewritten. The same applies to a later described step #716.

Further, when the web page 62 corresponds to an attention screen (No in #713, Yes in #715), the image forming apparatus 1 rewrites the web page file 74 so that the entire background color of the web page 62 becomes the symbolic color, which is yellow, indicated in the design data 5B2 (#716).

Then, the image forming apparatus 1 displays the web page 62 based on the web page file 72 or image file 73, which is rewritten in step #714 or #716 according to need (#717).

According to the present embodiment, the image forming apparatus 1 displays the web page 62 corresponding to the design of the screen 61. With this configuration, user's operation error or uncertain determination can be reduced than before in a case where the image forming apparatus 1 provides the user with service via a native application and service via the Web.

According to the present embodiment, the object rewriting unit 105 rewrites the web page file 72 or image file 73 so that each color of the proceeding object, terminating object, and resetting object arranged on the web page 62 becomes same as the colors of the proceeding object, terminating object, and resetting object arranged on the screen 61. In other words, rewriting is performed so that the colors are changed to green, red, and yellow respectively. However, the colors do not have to be completely the same and only have to be a color in a wavelength band of green, a color in a wavelength band of red, and a color in a wavelength band of yellow.

For example, when the color of the proceeding object of the screen 61 is seychelles green, the color of the proceeding object of the web page 62 may not be limited to seychelles green and may be changed to bottle green, earth green, faction green, or the like.

In a similar manner, when the color of the terminating object of the screen 61 is flamingo orange, the color of the terminating object of the web page 62 may not be limited to flamingo orange and may be changed to orient red, dusty pink, faction red, or the like.

In a similar manner, when the color of the resetting object of the screen 61 is panama yellow, the color of the resetting object of the web page 62 may not be limited to panama yellow and may be changed to core egg yellow, mellow yellow, faction yellow, or the like.

In a similar manner with the background color of the web page 62, the object rewriting unit 105 changes the color to any color in an orange wavelength band when the web page 62 is a warning screen and changes the color to any color in a wavelength band of yellow when the web page 62 is an attention screen.

According to the present embodiment, the colors of the proceeding object, terminating object, and resetting object of the screen 61 are associated with each keyword in advance and stored in the attribute table storage unit 101 as design data 5A1 to 5A3. Then, the certain object selection unit 104 selects the proceeding object, terminating object, and resetting object of the web page 62 based on the design data 5A1 to 5A3.

However, a determiner may be provided to the image forming apparatus 1 and the determiner may determine the color of the respective proceeding object, terminating object, and resetting object of the screen 61 by analyzing the screen 61. Then, the certain object selection unit 104 may select the objects based on the determination result.

For example, the determiner may extract a color of each outer frame of the proceeding object, terminating object, and resetting object and determine that each of the extracted colors is the color of the objects, respectively.

Further, the determiner may extract a color which is most used in background of the respective proceeding object, terminating object, and resetting object, and determine that each of the extracted colors is the color of the object, respectively. The colors of the warning screen and attention screen may be determined in the similar manner.

According to the present embodiment, the object rewriting unit 105 rewrites the web page file 72 or image file 73 so that each color of the proceeding object, terminating object, and resetting object arranged on the web page 62 is changed However, in a case where the proceeding object, terminating object, and resetting object arranged on the screen 61 have different shapes from one another, the object rewriting unit 105 may rewrite the web page file 72 or image file 73 so that each shape of the proceeding object, terminating object, and resetting object arranged on the web page 62 is changed

For example, in a case where the outer shape of the proceeding object, terminating object, and resetting object arranged on the screen 61 is a rectangular shape, an elliptical shape and a triangular shape, respectively, the object rewriting unit 105 rewrites the web page file 72 or image file 73 so that each shape of the proceeding object, terminating object, and resetting object arranged on the web page 62 becomes a rectangular shape, an elliptical shape and a triangular shape, respectively.

The present embodiment has described that the object rewriting unit 105 rewrites the web page file 72; however, in a case where a Cascading Style Sheets (CSS) file is downloaded together with the web page file 72, the CSS file may be rewritten.

The present embodiment has described the case where objects are classified into three categories including the proceeding object, terminating object, and resetting object, as an example; however, the present invention may be applied to a case of a different combination. For example, as a substitute for the resetting object, an object (attention-category object), which gives an instruction for a process that attention is needed when the process is executed, may be employed. The same applies to the categories of the screens.

In addition, the entire or a part of the configuration of the image processing system 4 and image forming apparatus 1, processing content, order of processes, data configuration, screen configuration and the like can be modified according to need within the scope of the present invention.

Although embodiments of the present invention have been described and illustrated in detail, the disclosed embodiments are made for purposes of illustration and example only and not limitation The scope of the present invention should be interpreted by terms of the appended claims

What is claimed is:

1. An image forming apparatus that executes a previously provided application, the image forming apparatus comprising
a displayer that causes a display to display a web page corresponding to a screen design of the application.

2. The image forming apparatus according to claim 1, wherein
the screen includes a plurality of first objects having different categories of usage,
each of the plurality of first objects has a mode corresponding to the category,
the web page includes one or more second objects, and
the displayer causes the display to display the respective one or more second objects in the respective modes of the categories so that the web page is displayed corresponding to the design.

3. The image forming apparatus according to claim 2, wherein
as the modes of the respective categories, colors in wavelength bands which are different from one another are used.

4. The image forming apparatus according to claim 3, wherein
as the categories, there are a first category to which an object that instructs to proceed the process to a next step in the plurality of first objects belongs, a second category to which an object that instructs to terminate or cancel the process belongs, and a third category to which an object that instructs to reset to an initial state belongs, and
as the modes of the first category, the second category, and the third category, colors of a green-like color, a red-like color, and a yellow-like color are used, respectively.

5. The image forming apparatus according to claim 2, wherein
as the modes of the respective categories, shapes which are different from one another are used.

6. The image forming apparatus according to claim 1, further comprising:
an obtainer that obtains reproduction data for reproducing the web page; and
a rewriter that rewrites the reproduction data according to the design, wherein
the displayer causes the display to display the web page based on the reproduction data rewritten by the rewriter.

7. The image forming apparatus according to claim 2, further comprising:
a storage that stores mode data indicating the modes of the respective categories while associating with a keyword;
an obtainer that obtains reproduction data for reproducing the web page;
a determiner that determines the category of the respective one or more second objects based on the reproduction data and the mode data; and
a rewriter that rewrites the reproduction data so that the one or more second objects respectively become in the mode indicated by the mode data of the respective categories determined by the determiner, wherein
the displayer causes the display to display the web page based on the reproduction data rewritten by the rewriter.

8. The image forming apparatus according to claim 2, further comprising:
a specifier that specifies the mode of the respective categories by analyzing the plurality of first objects;
an obtainer that obtains reproduction data to reproduce the web page;
a determiner that determines the category of the respective one or more second objects based on the reproduction data; and
a rewriter that rewrites the reproduction data so that the respective one or more second objects become in the modes, which is analyzed by the specifier, of the respective categories determined by the determiner, wherein
the displayer causes the display to display the web page based on the reproduction data rewritten by the rewriter.

9. The image forming apparatus according to claim 1, wherein
as the screen, a plurality of screens having a different background of the entire screen or a title corresponding to a type of a message to be notified to a user are prepared, and
the displayer causes the display to display the web page corresponding to the design by displaying a specific area of the web page with the background of the screen of a type which is same as the type of the web page, from the plurality of screens.

10. The image forming apparatus according to claim 9, wherein
as the types, there are a first type for warning and a second type for calling attention, and
as the backgrounds of the first type and second type, a red-like background and a yellow-like background are used, respectively.

11. A web page display method for displaying a web page in an image forming apparatus in which an application is previously provided, the web page display method comprising
causing a display to display the web page corresponding to a screen design of the application.

12. A non-transitory recording medium storing a computer readable program used in an image forming apparatus that executes a previously provided application, the computer readable program causing the image forming apparatus to perform
a display process for causing a display to display a web page corresponding to a screen design of the application.
